(19) United States
(12) Patent Application Publication
(10) Pub. No.: US 2023/0098250 A1
(43) Pub. Date: Mar. 30, 2023

(54) System and Method for Scheduling

(71) Applicant: Ryan Leon Wright, Cheyenne, WY (US)

(72) Inventor: Ryan Leon Wright, Cheyenne, WY (US)

(21) Appl. No.: 17/952,880

(22) Filed: Sep. 26, 2022

Related U.S. Application Data
(60) Provisional application No. 63/248,495, filed on Sep. 26, 2021.

(51) Int. Cl. G06Q 10/10; G01C 21/34

(52) U.S. Cl. CPC G06Q 10/1095; G01C 21/3407; G01C 21/3492

(57) ABSTRACT

The present systems and methods relate to optimizing scheduling of appoints and or services via coordination between user calendars and service providers calendars. In some embodiments, opportunistic scheduling is performed when the systems and associated methods identify unsatisfied service needs on a user's calendar based on historic data, openings in the user's and service provider's calendars, and user and service provider location and/or time required to satisfy the appointments/service need.

### CROSS REFERENCE TO RELATED APPLICATIONS

This application claims priority to U.S. Provisional Application Ser. No. 63/248,495, filed Sep. 26, 2021, which is hereby incorporated by reference in its entirety.

### BACKGROUND

The field of the invention relates generally to appointment scheduling and service provider search and matching, and more particularly, to systems and methods for matching and scheduling appoints for goods and services for a user via ranking and matching algorithms.

### SUMMARY OF THE INVENTION

In one aspect, the present service request system is configured with a request processor having an input and output system (I/O) for communication with at least one remote user device and configured to receive and process a service request from the at least one user device. The service request system may also include a service provider database for storing data associated with one or more service provider, a ranking system for generating a ranking of the one or more service providers, and a profile matching engine. A service provider comparator may also be included to generate a list of service providers based on the ranking system generated ranking and one or more User Preferences communicated via the I/O from the user device and/or user profile data. Finally, an appointment updater may be provided for updating one or both of an appointment calendar associated with the user device and the one or more service providers.

In another aspect, method for satisfying an unsatisfied appoint or service is provided. Such as method determines a user's location and identifies one or more unsatisfied appointments or services for the user. The method then identifies one or more opportunities to satisfy the unsatisfied appointments or services by one or more service providers within a distance from the user's determined location and providing the one or more opportunities to the user to satisfy the one or more unsatisfied appointments or services by the one or more service providers.

In another aspect, the service request system includes a request processor having an input and output (I/O) system for communication with at least one remote service provider device and configured to receive and process a business request from the at least one service provider device. The service request system further includes a service provider database for storing data associated with one or more service provider and a ranking system for generating a ranking of the one or more service providers. The service request system also includes a profile matching engine for matching a plurality of user's profiles with a criteria data submitted by the service provider and an appointment updater for updating one or both of an appointment calendar associated with the user device and the one or more service providers.

### BRIEF DESCRIPTION

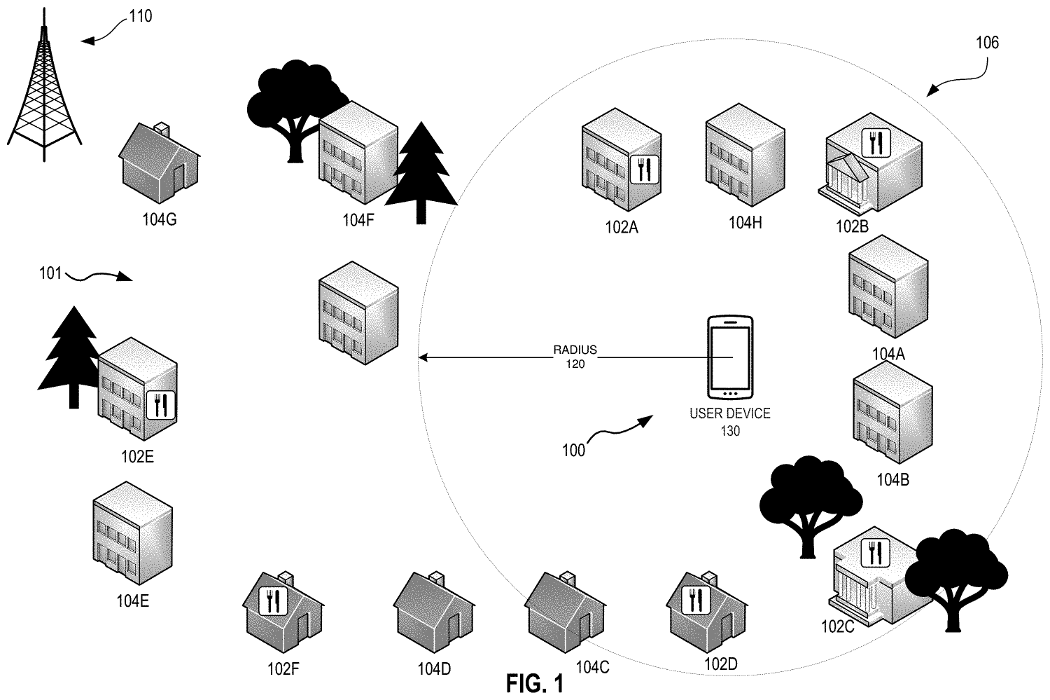

FIG. 1 shows one system for scheduling a service, in an embodiment.

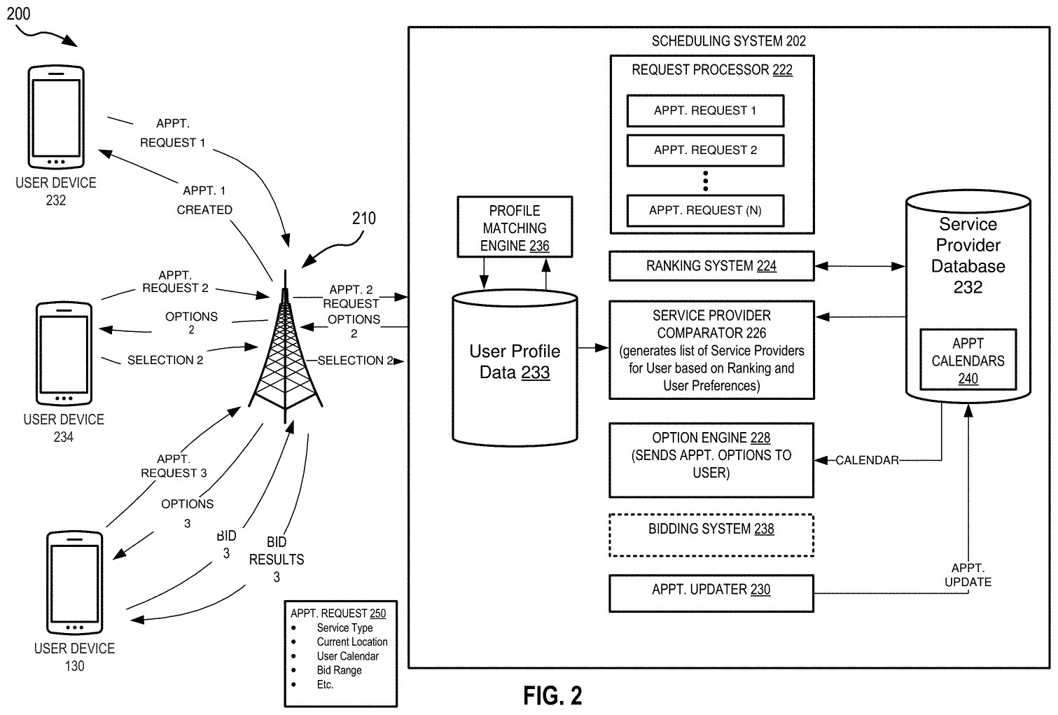

FIG. 2 shows one exemplary embodiment of the scheduling system of FIG. 1.

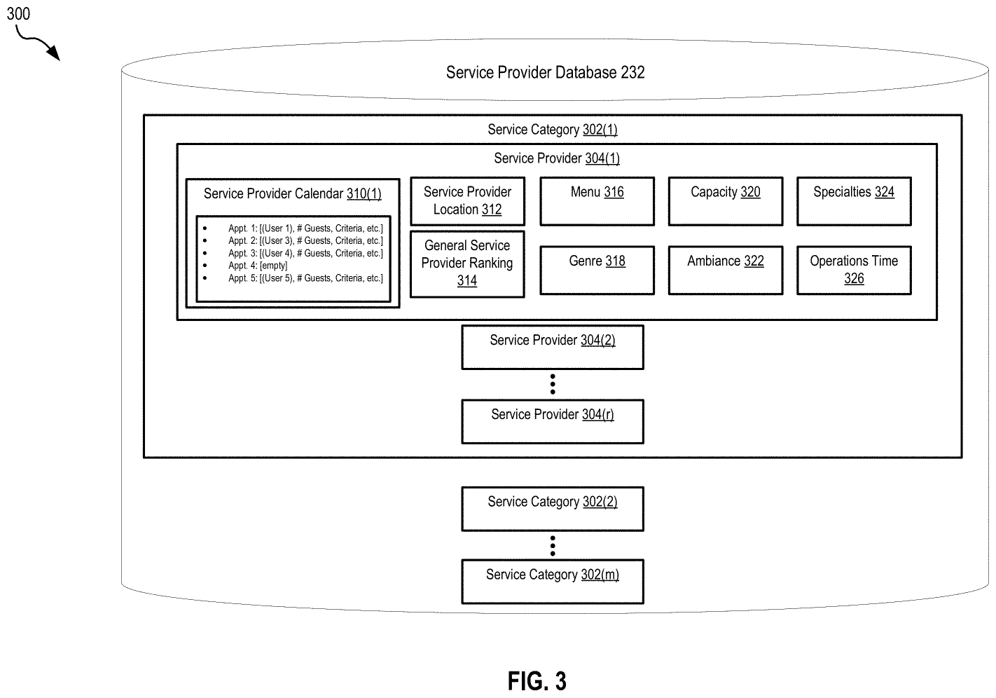

FIG. 3 shows one exemplary embodiment of a Service Provider Database.

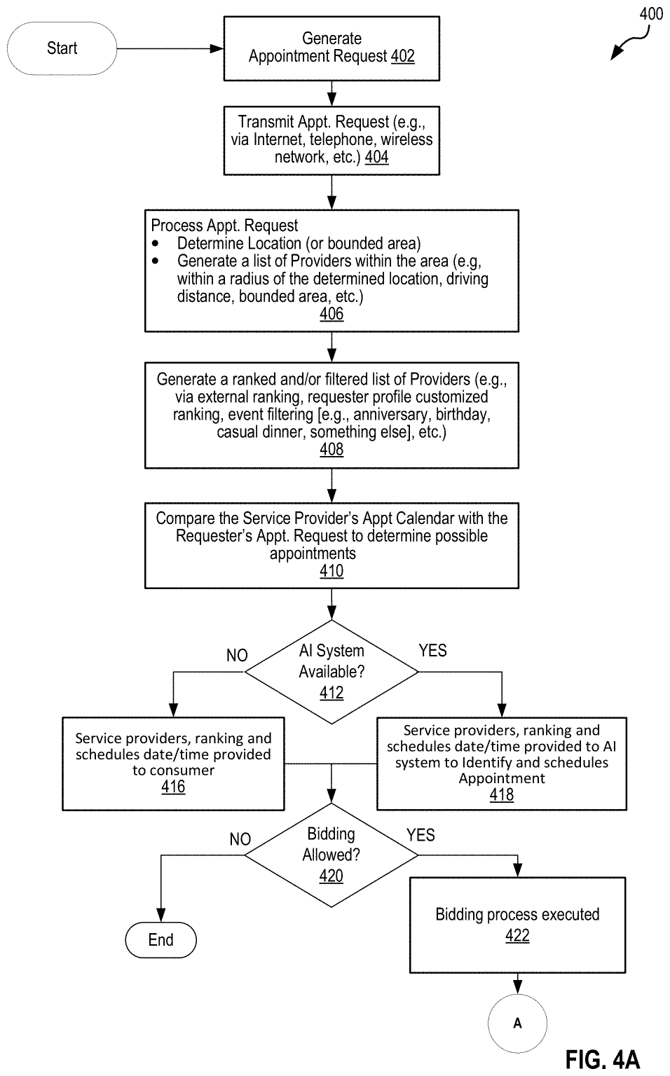

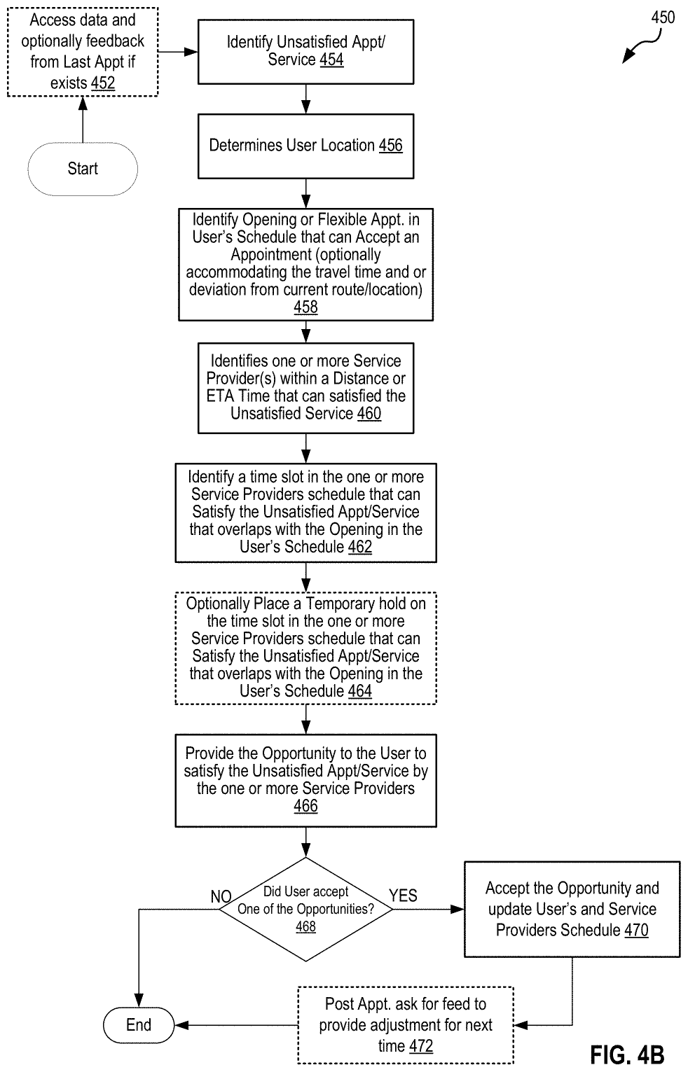

FIG. 4A is a method of operation of the system of FIG. 1-3, in an embodiment.

FIG. 4B is an Artificial Intelligence (AI) enabled method of operation of the system of FIG. 1-3, in an embodiment.

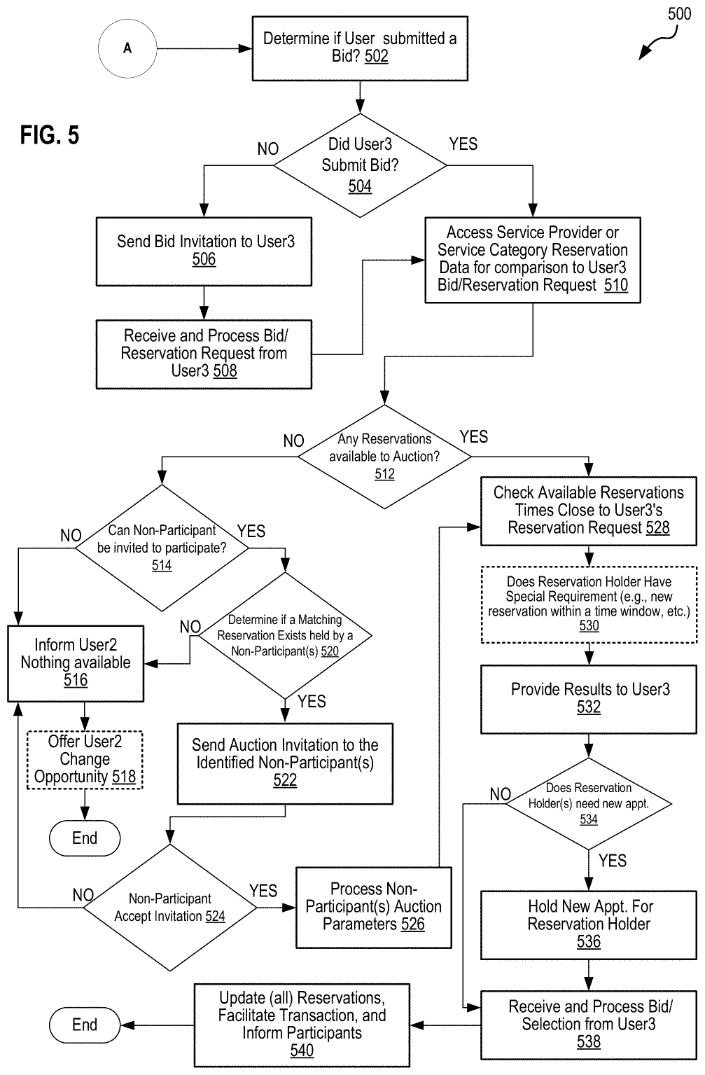

FIG. 5 is a method of operation of one exemplary auction-based embodiment of the system of FIG. 1-3, in an embodiment.

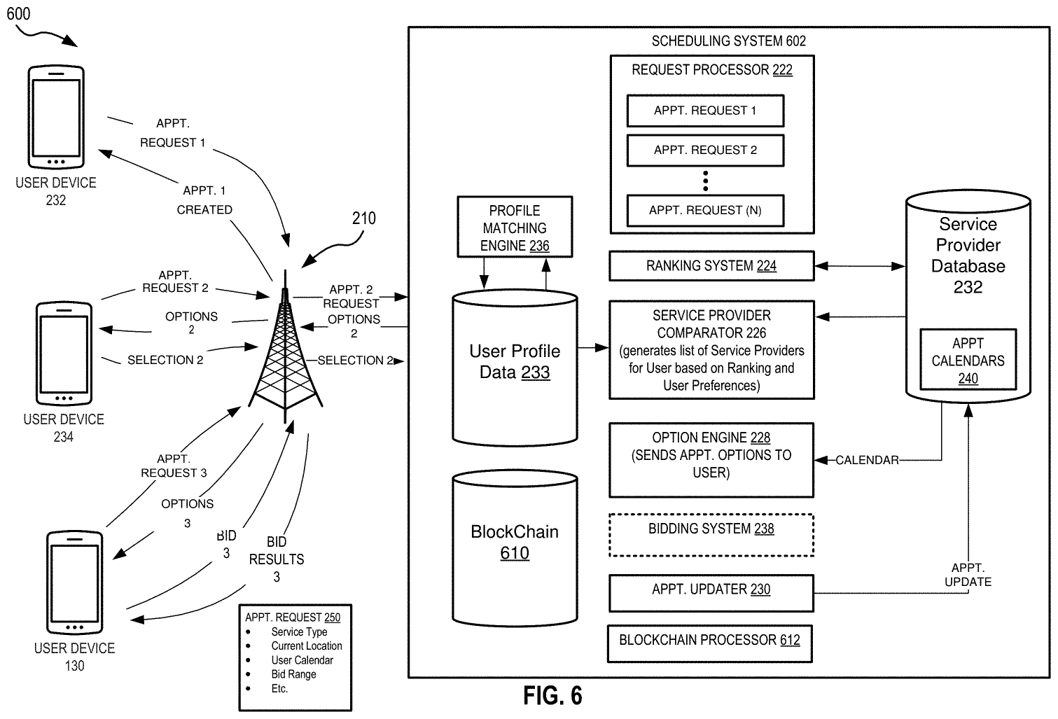

FIG. 6 shows one exemplary embodiment of the scheduling system of FIG. 2, including blockchain functionality.

### DETAILED DESCRIPTION

FIG. 1 shows one exemplary scheduling system 100 in operation within area 101. In one exemplary embodiment, the input/output (I/O) portions of system 100 are implemented in part by using device 130, which is communicatively coupled with scheduling system 202, shown in FIG. 2 and discussed below. Utilize 130 may be communicatively coupled to scheduling system 202 via, for example, a tower 110 or via some other wired or wireless mechanism such as but not limited to a Wi-Fi hotspot, Wi-Fi AP, a macro cell tower, a small cell, a gNodeB, a eNodeB, a 5G access point, a 5G NR-U access point, etc.

In one embodiment, the plurality of services may be provided to the user via the user device 130. The plurality of services may be reduced by, for example, a spatial parameter. Spatial parameter may be, for example, a radius 120 from user device 130 which defines a bounder area 106, a Geo-fenced area could determine by or otherwise selected by the system 100 or a user via user device 130 and associated, directly connected or indirectly connected second device. Nonlimiting examples of the second device include a laptop, a desktop computer, a tablet computer, a smart input/output device, smart speaker, smart television, smart functionality implemented into a home or a vehicle, etc.

In the embodiment shown in FIG. 1 at such services may be for example restaurants 102 A-F. Special limitation provided by radius 120 include restaurants 102A-D and exclude restaurants 102E and F. Other services may be provided by service providers 104A-G. Nonlimiting examples of such services provided by switch providers 104A-F include hairdressers, dentist's office, doctor's office, mechanics, etc. or any other's service provider that may be contained within (or in close proximity to) the spatial region.

FIG. 2 shows a system 200 for facilitating the scheduling of an appointment.

System 200 includes a scheduling system 202, user devices 232 and 234, previously discussed user device 130 (shown in FIG. 1), and wireless connection 210, one nonlimiting example of a communication link. User devices 232, 234, 130 wirelessly communicate with scheduling system 202 via wireless connection 210.

In the nonlimiting embodiment shown in FIG. 2, user device 232 is a user device that does not participate in scheduling system 202. User device 234 does participate in scheduling system 202. User device 234 generates an appointment prior to user device 130, the process which will be discussed below. User device 130 participates in scheduling system 202 and attempts to schedule an appointment after user device 234. In one optional embodiment user device 130 utilizes a bidding or offer system discussed in more detail below in FIGS. 4 through 6. Processes utilized by user devices 232, 234, and 132 create an appointment will be discussed below.

Scheduling system 202 is shown to include a request processor 222, a ranking system 224, a service provider comparator 226, an option engine 228, and employment 230, a service provider database 232, a user profile database 233, a profile matching engine 236, and functional bidding system 238. Request processor 222 is shown to include appointment request 1-N. Service provider database 232 is shown to include appointment calendars 240. In the exemplary embodiment shown in FIG. 2 service provider database 232 is communicatively coupled with ranking system 224, option engine 228 via a calendar functionality, and appointment updater 230 via an appointment up the functionality. In one embodiment ranking system 224 is configured as a closed system that only take in data from within scheduling system 202 and its users. In a separate embodiment, ranking system 224 pulls ranking data from external sources, such as but not limited to public online sources (Yelp™, the Better Business Bureau, Google™, etc.). In yet another embodiment, a combination of internal ranking and external sources are utilized in combination. When utilizing an external source, a normalization process may be employed. In addition, a weighting function may be used to provide greater weight to the various sources, e.g., more weight may be given to the internal ranking, highly reliable sources, etc. Lower weighting may be applied to less reliable sources, e.g., self-reported rankings, ranking with a low number of reviewers, etc. In addition, service provider comparator 226 is in communication with service provider database 232 and user profile database 233. User profile database 233 is also in communication with profile matching engine 236. It will be understood by the skilled artisan that the components, their arrangement and configurations, and their communication connections shown in system 200 and throughout the present application are only for ease of explanation and not meant to be limited in any. For example, each element of scheduling system 202 may include more or fewer communication connections, appointment calendars 240 may be included within or completely separate from one or more other elements within scheduling system 202, and one or more of the shown functions may be optional. In addition, some communication connections are shown as unidirectional while others are bidirectional. This may not always be the case and may be implementation specific.

One nonlimiting example, user device 232 may send an appointment request 1 either to scheduling system 202 via wireless connection 210, or via prior art techniques. If utilizing scheduling system 202 appointment request 1 may be processed by request processor 202 and appointment calendar 240 may be updated within service provider database 232. In addition, an appt. 1 created message may be sent back to user device 232. If using prior art techniques, then user device 232 or the owner thereof may be informed that appointment has been created by known methods.

In a another nonlimiting example, user device 234 sends an appointment request to the scheduling system 202 via wireless connection 210. Appt. 2 request is processed by request process 222 which accesses the service provider database 232 to determine if a requested appointment slot is available. If the request is slot is available scheduling system 202 sends send an appointment to created message (not shown) to the user device 234. If it is determined that the requested slot is not available scheduling system 202 will identify alternatives or options via option engine 228 and transmit the identified options in an options 2 message to user device 234. A user of user device 234 may then make a selection from the provided options 2 message and transmit that selection back to scheduling system 202 via a selection 2 message. Upon receipt of the selection 2 message scheduling system 202 updates the service providers calendar stored in appointment calendars 240 within service provider database 232. Optionally, and not shown, scheduling system 202 may send a calendar invite or calendar update to the user of user device 234 via the calendar functionality associated with that user and/or user device.

In a third example, user device 130 spends an appointment request 3 to scheduling system 202 via wireless connection 210. Request processor processes the received appointment request 3 to determine if the service provider has an appointment open at the request time. One example of request processor 222 determining if the requested service provider has an open appointment at the requested time is request processor 222 accessing the service provider's calendar within appointment calendars 240. If it is determined by request processor 222 that the appointment is available, then the request is satisfied in the process discussed above is utilized. If it is determined by request processor 200 for me to be that the appointment time is not available but other times are available than again press is utilized as discussed above for providing options to user device 130. If it is determined that no times are available but occupied timeslots are up for sale for example via a bidding or offering process, then one of the two processes are utilized here. For example, if no timeslots are available but occupied timeslots are up for bid, that is they can be purchased by the user of user device 130, scheduling system to be delivered to activates option engine 228 and a bidding system 238 to provide bidding options back to user device 130 bidding options may be provided via an options 3 message. Upon receipt of the options 3 messages, which includes the one or more biddable slots or appointments, the user of user device 130 may select one of those options with a user determined bid offering and transmit that back to scheduling system 202 via bid 3 message via wireless connection 210. Scheduling system 202 then utilizing bidding system 238 provides data associated with bid three message to the owner of the bid upon appointment. For example, the bid upon appointment may be owned by the user of user device 234. In such a case the bid message and/or its associated offer may be provided to the user of user device 234, which they may agree to or reject. The response to the bed is then sent back to scheduling system 202 process and the bid results are provided to user device 130 via a bid results 3 message. If the bid was accepted scheduling system 202 new updates the appointment calendar for example via appointment updater 230. Scheduling system 202 may also provide an alternative or replacement appointment to user device 234, discussed further below.

In one exemplary embodiment a user is looking for a service type, for example a restaurant, and not a specific service provider, for example Dot's Diner. In such an embodiment an appointment request message may be sent, for example, by means of appointment request 250. In such an embodiment appointment request message 250 is sent, for example, via an appointment request messages similar to appointment request 3 message. In the simplest embodiment, appointment request message 250 is processed by request processor 222 which accesses service provider database 232 to determine a service provider within proximity of user device 130. Within proximity of user device 130 may be, for example, within the radius 120 of user device 130. If only one service provider is within proximity of user device 130 than that service provider is presented to user device 130, for example via an options message including available appointments. If more than one service provider is within proximity of user device 130 a service provider comparison may be utilized.

One exemplary service provider comparison methodology, which may be utilized by scheduled system 202, is ranking service providers and storing those rankings within service provider database 232. A more refined ranking methodology may include leveraging data associated with a user via user profile database 233. Such a method may allow users (ideally users with a user profile contained within the user profile database 233, although this is not necessary) of scheduling system 202 to rank or order service providers. Such an embodiment may utilize the profile matching engine 236 to match a first user profile, for example the user of user device 130, with one or more other user profiles contained within user profile database 233 that have associated with them one or more rankings of service providers. The idea being that a first group of users may rank Michelin Star restaurants very high, while a second group of users may rank food trucks very high. Therefore, the user's profile that is associated with a user performing a current search should first be matched with user profiles in a same or similar preference group such that a recommendation based on a historic ranking best matches the preferences of the user performing the search. In a related embodiment, a reservation may be associated with a compound profile. A compound profile may be, for example, a combination or linking of two or more profiles, or may be the inclusion of a second person data to a first profile for purposes of a search. In use, a compound profile may be a first user having a first profile that is augmented with a second person profile/data making a reservation for dinner. If the first user were to make a reservation using only their own profile that user may get suggestions for Michelin Star restaurants. If the first user were to make reservations with their profile augmented with the second persons profile/data (and preferences and/or dietary restrictions) then suggestions may be provided by the system 202 that would not have been provided if the request was made under only the first user profile alone. For example, the system may provide results for outdoor dinning on the water, food trucks, or spicy Asian restaurants. In the same, similar, or related embodiments, system 202 may also take into account the number of individuals (and their preferences and/or dietary restrictions) on a reservation, such that a large group reservation would cause system 202 to exclude restaurants with maximum table sizes of six. Preferences and dietary restrictions may include but are not limited to food allergies, spice level, regional preferences, vegan, vegetarian and variants (e.g., Ovo-vegetarian, lacto-ovo-pescatarian, etc.), identified favorite or least liked foods, etc.

That is, system 202 may consider at least single user's profile, a compound profile, multiple user's profiles, and data included in the request to determine a result or list of results. System 202 may additionally take result feedback from a user to fine tune its process generally and/or specifically to that user. If generally then the system 202 may finetune its generally algorithm utilized for all users. If specific to a user, then the feedback based finetuning may be included within or associated with the user's profile.

In some embodiments, service providers associated with service provider data base 232, may also rank users associated with user profile data 233. This service provider ranking of users may be stored in one or both of user profile 233 and service provider database 232. Inputs into the service provider ranking of users may include positive and negative parameters, such as frequency of a user patronizes a business, tips ranges and/or average tip, preferred employee of the business (and least preferred), the users expected level of service, returns and or complaints, punctuality, cancellations, etc. The result of a service provider ranking of users can be utilized by the system to increase or decrease the ranking of a business in a user's search for services, for example, to reduce or increase the likelihood of the user patronizing the business based on the businesses preferences.

FIG. 3 shows one exemplary embodiment of Service Provider Database 232, shown in FIG. 2.

Service provider database 232 is shown to include service category data 302(1)-(m). Service category data 302(1)-(m) define different service categories, for example, service category data 302(1) may be related to restaurants, service category data 302(2) may be related to dentists, service category data 302(3) may be related to car dealerships, service category data 302(4) may be related to doctor offices, service category data 302(5) may be related to workout facilities, etc.

Service category data 302(1) is shown to include service providers 304(1)-(r), where each service provider 304(1)-(r) may be, by way of example, a specific named restaurant or a restaurant chain. Service provider 304(1) is represented in an expanded view to show some of the possible elements it may include. Some of these possible elements include, but are not limited to, a service provider calendar 310 for holding appointments/reservations, service provider location 312, a general service provider ranking 314, a menu 316, genre 318, capacity 320, ambiance 322, specialties 324, operation time 326, etc. It will be understood that this list of possible elements has both generic element and restaurant specific elements, it will also be understood that other service categories may have similar generic elements and may additionally include different possible elements that are directed to that type of service and parameters that are valued for that type of service. For example, for a dentist possible element may include “kid friendly” or “pain management”, for a doctor it may include “time in waiting room”, “insurance match”, for a hair dresser it may include types of hairstyles for matching to a user, “products for purchase”, or hairstylist specific services such as dyeing and coloring, blow dry, etc. As such, possible elements included within a service provider data, e.g., one or more of service provider 304, may be service category specific, service provider specific, one or more qualities important to users of system 202 (e.g., punctuality, no up-selling, cleanliness, etc.)

Service Provider 304 is shown in an expanded view and includes a service provider calendar 310, which holds appointments. Service provider calendar 310 may be synchronized with the service providers scheduling system outside of system 202. Alternatively, service provider calendar 310 may be a service providers scheduling calendar provided by system 202 or may be internally in-synch with a service providers scheduling calendar provided by system 202 to the service provider.

FIG. 4A is a method 400 of operation of the system 202 of FIG. 1-3, in one embodiment.

In step 402, method 400 generates an appointment request. One example of step 402 is user device 232, 234, 130 generating an appt request 1, 2, 3.

In step 404, method 400 transmits the appointment request via a communication link for processing. One example of step 404 is user device 232, 234, 130 transmitting appointment request 1, 2, 3 to system 202 via a wireless connection 210.

In step 406 method 400 processes the transmitted and received appointment request. Exemplary sub-steps of processing the received request is determine location or bounded area of the user device 232, 234, 130 and generate a list of service providers at the location or within the determined area (e.g., within a radius of the determined location, driving distance, bounded area, etc.). One example of step 406 is system 202 determining a location of user device 130 and a radius 120 to create a bounder area 106 from which a list of service providers can be generated.

In step 408 method 400 generates a ranked and/or filtered list of service providers from within the bounder area (e.g., via external ranking, requester profile customized ranking, profile matching, compound profile matching, event filtering [e.g., anniversary, birthday, casual dinner, something else], etc.). One example of step 408 is system 202 performing a profile matching process by profile matching engine 236 to match a user profile associated with user device 130 contained within user profile data base 234 with other user profiles having similar preferences, which may for example be service category specific, to generate a ranked list of service providers based in at least in part on the appointment request and the user's preference(s).

In step 410 method 400 compares the service provider's appointment calendar with the requester's appointment request to determine possible appointments. One example if step 410 is system 202 comparing the day and time the request to one or more service providers appointment calendars 240 to determine a match. In one non-limiting embodiment a match is this way filters out service providers that do not have an opening at the requested day and time. In a separate embodiment, for example an embodiment that provides a bidding or purchasing of an appointment, step 410 does not filter out service providers that do not have an appointment that matches the requested day and time, discussed more below.

In step 412 method 400 if an optional Artificial Intelligence (AI) system is implemented in system 202. One example of step 412 is identifying a system 202 implemented and or user dedicated AI agent that cooperates with system 202 to provide a user, e.g., though device 130, to assist the user.

If it is determined that no AI system is available in step 412 then method 400 moves to step 416 where method 400 provides a list of service providers that match the request to the user, for example, by providing a ranked list having selectable appointment options to the user via device 130. Method 400 then moves to optional step 420. If it is determined that an AI system is available in step 412 then method 400 moves to step 418 where method 400 provides the list of service providers having an appointment match with the request, for example, in a ranked list of service providers having available appoints, to the AI system which may identify and schedule an appointment on behalf of the user. Scheduling via the AI system may be via system 202 or may be through some other means, for example by the AI system or agent calling the service provider and having a telephone conversation to make the appointment or texting, e-mailing, or interfacing with a website or smart phone application to schedule the appointment. Method 400 then moves to step 420.

In optional step 420 method 400 determines if a bidding or offering system is available. If a bidding or offering system is available step 422 moves to step 422 where the bidding or offering system is engaged and method 400 moves to step 504 of method 500, FIG. 5. If no bidding or offering system is available, then method 400 ends.

FIG. 4B is an Artificial Intelligence (AI) enabled method of operation of the system of FIG. 1-3, in an embodiment, for scheduling an unsatisfied appointment. An unsatisfied appointment may include an appointment request that is not initiated by the user but by the AI system when it recognizes an unsatisfied appointment, for example a periodically occurring appointment (based on time) such as haircuts, doctor's physical, tire rotation, anniversary or an event driven appointment such as a vehicle maintenance check (based on mileage since last check or dealer/manufacturer information) or oil change (connected smart vehicle has hit a predetermined mileage), max or consistently high or low heart rate or blood pressure as measured by a smart or connected device, air duct cleaning, etc.

In optional step 452 method 450 accesses data and optionally feedback from the last appointment and if such a previous appointment and associated feedback data existed.

In step 454 method step 400 identify unsatisfied appointment/service. ON e example of step 454 is system 202 determining the periodicity of one or more events, for example on a user calendar, such as but not limited to a haircut, an oil change, a dental teeth cleaning, etc.

In step 456 method 450 determines the location of the user. Determining the location of the user may include determining the location of the user based on the location of user device 130. In addition, step 456 may also determine a bounder area that contains the user location, for example based on a radius 120 from user device 130, a symmetrical or non-symmetrical bounded area containing (although not necessarily centered on) the user or user device 130, or if a driving path in known to, for example system 202 or device 130, then a time (time based deviation from the traveled path) or distance (driving or as the crow flies distance based deviation from the traveled path) based measurement from that center of that path.

In step 458 method 450 identifies one or more opening in the user calendar or schedule or identifies flexible appt. in user's calendar or schedule that can accept a time slot to accommodate the unsatisfied appointment. Optionally the time slot may be expanded to accommodate any required the travel time and or deviation from current route/location if, for example, the user is traveling when method 450 is executed.

In step 460 method 450 identifies one or more service provider(s) within a distance or time window that can satisfied the unsatisfied appointment or service. It will be understood that the order of steps 456, 458, and 460 may be interchanged without departing from the scope here. It should also be understood that method 450 may perform steps 458 and 460 in a similar manner without departing from the scope here, such as but not limited to generating a list of unsatisfied appointments at a first instance in time, which are saved to memory, and at a later instance in time surveying a moving bounded are containing the user or users device for service providers that can satisfy one or more of those unsatisfied appointments. One example of step 460 is system 202 system 202 and or device 130 comparing the determined unsatisfied appointment or service with service providers within the bounded area 106 defined by radius 120 from device 130.

In step 462 method 450 identifies a time slot in the schedule of the one or more determined service providers from step 460 that can satisfy the unsatisfied appt/service that overlaps with the opening in the user's schedule or calendar. One example of step 462 is system 202 comparing time slots in a user's time calendar or schedule (not shown but may exist or a copy may exist within device 130 and/or system 202) with each service provides appointment/reservation calendar 240, 310(1)-(r).

In optional step 464 method 450 places a temporary hold on a determined time slot or opening in the one or more service providers schedule that can satisfy the unsatisfied appt/service that overlaps with the opening in the user's schedule. The purpose of this step is to ensure that the appointment is not taken by another before the user can make an appointment selection, see below. The temporary hold may be placed in more than one service provider calendars if a list of optional appointments is presented to the user, for example via user device 130. The temporary hold may expire automatically within a pre-designated time window or may removed by system 202 if a selection is made or is no selection is made.

In step 466 method 450 provided the opportunity to the user to satisfy the unsatisfied appointment or service by the one or more service providers by, for example, providing to the user via user device 130 one or more opportunities based on the above steps for satisfying the appoint or service.

In decision step 468 method 450 determines if did the user accepted one of the opportunities. If it is determined that the user did not accept one of the opportunities, then method 450 ends. If it is determined that the user accepted one of the opportunities then method 450 moves to step 470, where method 450 accepts the opportunity and updates the user's and service providers schedule or calendars. Optionally system 202 may help to facilitate the appointment by communicating with the user via a communication account or user device 130 to inform the user that a change has occurred, providing driving directions, look for service discounts (a step that may optionally occur earlier to help find, rank, or filter service providers), etc. Method 450 then moves to optional step 472 where method 450 asks, post appointment ask for feed on the service provider to adjust the general, and optionally the user or user group specific ranking for future searches. Method 450 then ends.

FIG. 5 is a method 500 of operation of one exemplary auction or bidding-based embodiment of the system of FIG. 1-4B, in an embodiment.

In step 502 method 500 processes received data to determine, in step 504, if a user has submitted a bid for a filled reservation. If step 504 determines the user has not submitted a bid then method 500 moves to step 506 where method 500 sends a bid request to the user, the response of which is received and processed in step 508, at which point method 500 moves to step 510. If it is determined in step 504 that the user did submit a bid, then method 500 moves to directly to step 510.

In step 510 method 500 accesses the service provider(s) or service category reservation data for comparison to the received user bid/reservation request.

In decision step 512 method 500 determines if any reservations available for auction. IF it is determined that no reservations are available for auction then method 500 moves to decision step 514 where method 500 determines if a nonauction participant can be invited to participate. If it is determined in step 514 that nonauction participants can not participate that method 500 moves to step 516 where it informs the user, e.g., via user device 130, that no bidding opportunities are available. Method 500 then moves to optional step 518 where method 500 provides the user, e.g., via user device 130, to amend the request, at which point the method either ends or move to back to method 400.

If in step 514 it is determined that nonparticipants can be invited to participate method 500 moves to decision step 520 where method 500 determine if a matching reservation exists held by a non-participant(s). If it is determined in step 520 that no reservation are available method 500 moves to step 516, described above. If it is determined that there is a reservation help be a nonparticipant then method 500 moves to step 522 where method 500 sends an auction invitation to the identified non-participant(s) for the reservation(s). Method 500 then moves to step 524 where method 500 determines if the nonparticipant accepted the invitation to participate. If it is determined that the nonparticipant will not participate then method 500 moves to step 516, described above. If it is determined that the nonparticipant will participate then method 500 moves to step 526.

In step 526 method 500 processes the non-participant(s) auction parameters to convert the nonparticipant to a participant.

In step 528 method 500 checks the available reservations times close to the user's reservation request.

In optional step 530 method 500 checks to determine if the reservation holder(s) have identified special requirement for giving up their reservation, for example, only if a new reservation can be obtained earlier or later, only to veterans, only for anniversaries, etc.

In step 532 method 500 provided the results to, for example, in a selectable list form via device 130.

In step 534 method 500 determines if the participant/original reservation holder requires a new/replacement reservation. If it is determined that the original reservation holder does require a new reservation then method 500 moves to step 536 where method 500 finds and places a hold on a new reservation that matches the original reservation holder's criteria, at which point method 500 moves to step 538. If it is determined in step 534 that the original reservation holder does not require a new reservation, then method 500 moves to step 538.

In step 538 method 500 receive and process bid/selection from the bidding/requesting user, for example, via device 130.

In step 540 method 500 updates all reservations, facilitate the transaction, and inform participants of the outcome, at which point method 500 ends.

FIG. 6 shows a system 600 and scheduling system 602, which is similar to system 200 and scheduling system 202 of FIG. 2 but modified to include a blockchain element 610 and blockchain processor 612.

Block chain 610 logically represents a distributed, immutable ledger for recording scheduling system 202 events and transactions. Blockchain processor 612 is logically represented as processing units for processing data for addition to blockchain 610.

Blockchain 610 and blockchain processor 612 are described as logically represented because they are shown as single elements when in fact they may be a plurality of elements distributed within or outside scheduling system 202. For example, block chain processor 612 may be located at a central office or may be distributed to some or all service providers devices and/or users devices. Alternatively, blockchain processers 612 may be provided by one or more third parties. Similarly, blockchain 610 may be located at a central office, may be distributed to some or all service provider devices and/or user devices, or provided by one or more third parties.

System 202 may utilize distributed appointment ledgers to confirm and/or record the status of an appointment. The present embodiments may be implemented to augment or, in some circumstances, replace conventional calendar and/or appointment tracking systems and methods. The distributed appointment ledgers utilized here may include, for example, blockchain technology to create digital ledgers for tracking the status, location, and/or disposition of scheduling system 202 data, including but not limited to appointment days/times, user data, service provider data, the exchange of appointments via auction and or sale, etc. For ease of explanation, the following description references blockchains as an exemplary embodiment of distributed ledger technology. A person of ordinary skill in the art though, upon reading and comprehending the present description and associated illustrations, will understand that other examples of distributed ledger technologies may be implemented according to the novel and advantageous principles herein.

The present solutions may be implemented as either standalone systems, or as complementary systems to conventional recording systems that rely on trusted parties manually recording events into databases or other record keeping mechanisms, often using trusted labels. In such systems, it is important to track and verify information (e.g., specific times, location, duration, quantity, status etc.) of scheduling system 602 data.

According to the embodiments herein, digital ledgers are implemented to create secure and immutable records of transactions regarding appointments, transactions, user and service provider data, etc. In these records, the transaction information is encoded into formats, digitally signed using a cryptographic technique, and submitted to a network of processors of a distributed ledger network. The processors validate the submitted transactions for accuracy, and the validated transactions are subsequently added to a queue or stack of the ledger. At some point, according to a predetermined criterion (such as, but not limited to, an interval of time, a volume of data, a number of transactions and/or appointments, or combination of these and other factors), the queued or stacked transactions are sequentially hashed (e.g., using a Merkle process), and collectively encoded into a block which is then hashed with the hash of the proceeding block using cryptographic processes. An algorithm will allow multiple processors to select a block from amongst many processors to be the block added to the blockchain.

In an exemplary embodiment, the distributed ledger is a blockchain. Blockchaining technology takes transaction information, encapsulates it in a digital envelope or “block” and then the block is cryptographically added (using cipher chaining techniques) to the end of a chain of other transactions. This cryptographic addition incorporates information from prior blocks on the chain to calculate the digital chain or “hash” for this new block. The calculations for cryptographic addition can vary widely in complexity based on the rules of the blockchain. This complexity is purposeful though, in order to prevent modification of the existing blockchain to which is being added. That is, in order to modify an earlier block in the chain, the entire chain from that point forward would need to be recalculated. It is through this technique that the immutability of the chain, and permanency of its public ledger, is maintained.

The embodiments described herein are particularly useful for reliably associating appointments or transactions with a particular person. As described herein, details of transaction events (e.g., dates, times, current status, changes in status, the sale to another user, etc.) for an appointments or scheduled service are encoded into a cryptographically signed and protected transaction that is submitted to a distributed ledger network, such as a blockchain network, for further processing. Processors of the distributed network process the incoming transactions into blocks, which may then be added to a particular blockchain. Once added to the blockchain (or equivalent entry in an electronic distributed ledger), the transaction may be visible to, but immutable by, appropriate parties that seek to create a service or appointment, future or historic. Such calendar/appointments may then be more easily verified on the ledger, while being rendered more difficult to alter once added to the ledger. In some embodiments, the ledgers further track the association of persons to devices utilized in the system.

In an embodiment, the application of a blockchain or cryptographic distributed ledger to the present invention protects scheduled appointments. Such an applications creates an immutable appointment calendar, although changes may be made by the user (and possible the service provider), for example when an appointment is cancelled or provided to a second user. Moving to an appoint to a second user may be a sale of the appointment, an auctioning of the appointment, or even gifting the appointment to the second user. While appointment and data (e.g., user or service provider data) changes may occur and be recorded to the block chain an immutable and auditable history of the transactions are maintained. It this way, the scheduling and transaction systems disclosed here are protected.

In one or more embodiments, the present system and methods may utilize a digital currency, i.e., a scheduling system digital currency. Such a scheduling system digital currency may be utilized to pay for services scheduled via the present systems and methods. Further, the scheduling system digital currency may also be used to purchase appointments from other users, e.g., via a direct sale or an auction of an appointment or service.

The scheduling system digital currency may be recorded on the blockchain, for example, when first purchased or when a transaction occurs. Purchasing scheduling system digital currency may be done by exchanging one or more of national currencies (e.g., US Dollars) or other digital currencies (e.g., Bitcoin) for scheduling system digital currency. Scheduling system digital currency may also be earned via providing services or by participating in the blockchain processing.

Blockchain element 610 is configured to ingress data from system 202 and user devices, such as user devices 130, 234, and 232. Examples of data that may be ingressed into blockchain 610, and therefore included in a block on the chain, may be one or more of appointment data, appointment request data, appointment calendar data, service provider data, user profile data, transaction data, scheduling system digital currency, scheduling system transaction data, profile matching data, ranking data,

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A service request system, comprising:
a request processor having an input and output system (I/O) for communication with at least one remote user device and configured to receive and process a service request from the at least one user device;
a service provider database for storing data associated with one or more service provider;
a ranking system for generating a ranking of the one or more service providers;
a profile matching engine;
a service provider comparator configured to generate a list of service providers based on the ranking system generated ranking and one or more User Preferences communicated via the I/O from the user device and/or user profile data; and
an appointment updater for updating one or both of an appointment calendar associated with the user device and the one or more service providers.

2. The system of claim 1, further comprising a bidding system.

3. The system of claims 1, wherein the service provider database further comprises at least a service category database.

4. The system of claim 3, wherein the service category database

5. The system of claim 1, further comprising an option engine for generating appointment options for a user associated with the user device.

6. A method for satisfying an unsatisfied appoint or service, comprising:
determining a user's location;
identifying one or more unsatisfied appointments or services;
identifying one or more opportunities to satisfy the one or more unsatisfied appointments or services by one or more service providers within a distance from the user's determined location; and
providing the one or more opportunities to the user to satisfy the one or more unsatisfied appointments or services by the one or more service providers.

7. The method of claim 6, where the distance from the user's determined location is a spatial distance.

8. The method of claim 7, where the distance from the user's determined location is a time to travel.

9. The method of claim 8, where the time to travel is a function of speed limits between the user's determined location and a destination where the one or more unsatisfied appointments or services can be satisfied.

10. The method of claim 8, where the time to travel is a function of traffic between the user's determined location and a destination where the one or more unsatisfied appointments or services can be satisfied.

11. The method of claim 6, where the step of identifying an opportunity to satisfy the one or more unsatisfied appointments or services includes accessing the user's calendar and a service providers appointment calendar to determine a time slot that includes an opening in both the user's calendar and the service providers appointment calendar that sufficiently overlaps for satisfying the appointment.

12. The method of claim 6, wherein determining a time window that includes an opening in both the user's calendar and the service providers appointment calendar that sufficiently overlaps for satisfying the appointment includes a travel buffer between the identified opportunity to satisfy the one or more unsatisfied appointments or services and a next appointment on the user's calendar.

13. The method of claim 6, further comprising placing a temporary hold on the time slot in the one or more service providers appointment calendar that can satisfy the unsatisfied appt/service that overlaps with the opening in the user's schedule.

14. The method of claim 6, further comprising the step of receiving a user acceptance message from the user device and updating both the user's calendar and the service providers appointment calendar.

15. The method of claim 6, further comprising receiving service provider feedback from the user's device and updating a service provider database with data associated with the received service provider feedback.

16. The method of claim 6, further comprising receiving service provider feedback from the user's device and updating a user's preference profile based on data associated with the received service provider feedback.

17. The system of claim 1, further comprising a blockchain element for securely storing the updated appointment calendar associated with the user device and/or the one or more service providers.

18. A service request system, comprising:
a request processor having an input and output (I/O) system for communication with at least one remote service provider device and configured to receive and process a business request from the at least one service provider device;
a service provider database for storing data associated with one or more service provider;
a ranking system for generating a ranking of the one or more service providers;
a profile matching engine for matching a plurality of user's profiles with a criteria data submitted by the service provider; and
an appointment updater for updating one or both of an appointment calendar associated with the user device and the one or more service providers.

19. The method of claim 18, wherein the profiling matching engine generates a list of users based on a ranking system generated ranking of the users by one or more of other users and other service providers.

20. The method of claim 18, wherein the profiling matching engine generated list matches one or more of the users and the service provides data associated with location, ranking, genre, menu, capacity, ambiance, operations time, and health guidelines.

21. The method of claim 18, wherein the profiling matching engine generated list is utilized by the service provider to communicate with one or more users regarding a closeness match.

22. The method of claim 18, wherein the profiling matching engine generated list is utilized by the service provider to communicate with one or more users regarding an incentive to utilize the service provider's services.

23. The method of claim 18, wherein the profiling matching engine generated list is utilized to present to a user an elevated opportunity to satisfy the user's request.

24. The method of claim 23, wherein the elevated opportunity is in an elevated position in a list of opportunities presented to a user.

25. The method of claim 24, wherein the elevated opportunity is in an elevated position in a list of opportunities presented to a user based on a transaction between the service provider and the scheduling system.
